(19) United States
(12) Patent Application Publication
(10) Pub. No.: US 2008/0147694 A1
(43) Pub. Date: Jun. 19, 2008

(54) METHOD AND APPARATUS FOR STRATEGIC PLANNING

(76) Inventors: Leslie Mark Ernest, Knoxville, MD (US); Yingdong Lu, Yorktown Height, NY (US); Aleksandra Mojsilovic, New York, NY (US); Ana Radovanovic, New York, NY (US); Mark S. Squillante, Pound Ridge, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/611,809

(22) Filed: Dec. 15, 2006

(51) Int. Cl. G06F 17/30

(52) U.S. Cl. 707/101

(57) ABSTRACT

A structure (and method) for a computerized organization optimization tool includes an input port to receive one or more of: characteristics of at least one offering of the organization; characteristics of resources of the organization; and characteristics of constraints of at least one of the resources and the at least one offering. A calculator receives the characteristics to calculate one or more optimal targets for the organization.

### CROSS-REFERENCE TO RELATED APPLICATIONS

The present Application is related to the following co-pending application:

U.S. patent application Ser. No. 11/375,001, filed on Mar. 15, 2006, to Lu et al., entitled “Method and Structure for Risk-Based Workforce Management and Planning”, having IBM Docket YOR920050557US1, assigned to the present assignee, and incorporated herein by reference.

### BACKGROUND OF THE INVENTION

1. Field of the Invention

The present invention generally relates to a methodology of determining optimal targets for goals of an organization. In an exemplary embodiment, a computer tool allows the user to determine optimal target revenues for a business entity.

2. Description of the Related Art

Strategic planning is fundamentally important to any business entity. Its impact is pervasive throughout the organization as a key driver of financial success. One of the critical steps in strategic planning is determining revenue targets for different products/services, offered by the business entity, revenue targets for different organizations within the entity, and even structure of the organizations within the entity relative to strategic planning. So far, no formal methodologies exist to support or optimize strategic planning, particularly for the end results of an entity, such as determining an optimal revenue target for the entity.

The present inventors have recognized this problem and have developed a tool and method that can be used to optimize strategic planning for an organization, such as determining an optimal revenue target.

Although the following discussion is exemplarily oriented toward the goal of determining optimal revenue targets for a business entity, the concepts and the tool can be used for determining other types of goals and for other types of organizations, including, as nonlimiting examples, such entities as nonprofit organizations, government agencies, social organizations, and so on.

### SUMMARY OF THE INVENTION

In view of the foregoing, and other, exemplary problems, drawbacks, and disadvantages of the conventional systems, it is an exemplary feature of the present invention to provide a structure (and method) in which optimal targets are calculated for a different subcomponents of an organizational entity, given an overall target for the organization to achieve, a variety of quantifiable resources available, and one or more quantifiable demands.

It is another exemplary feature of the present invention to provide a tool to allow an organizational entity to calculate an overall target for the organization, as based upon such inputs as market conditions, business environment, best practices of competitors.

It is another exemplary feature of the present invention to provide a structure and method for, in one exemplary embodiment, calculating optimal revenue targets for different sectors of an organization, given an overall organizational revenue target and the resources and demands for that organization.

It is another exemplary feature of the present invention to provide a tool and method that can be used recursively, so that each subcomponent or sector of that organization can then calculate its own optimal revenue targets.

It is another exemplary feature of the present invention to provide a tool and method that can be used to calculate optimal revenue targets for an organization for a distant point in time by successively calculating optimal revenue targets for a sequence of business cycles.

It is another exemplary feature of the present invention to provide a tool and method that can similarly calculate optimal targets for any desired measurable result of an organization, given an overall organization target and a description of resources and demands.

It is another exemplary feature of the present invention to provide a tool and method that can calculate optimal targets for different offerings of an organization.

It is yet another exemplary feature of the present invention to allow an organization to determine an optimal mix of offerings, given one or more potential new offerings.

Therefore, in a first exemplary aspect, the present invention discloses a computerized organization optimization tool, including an input port to receive one or more of: characteristics of at least one offering of the organization; characteristics of resources of the organization; and characteristics of constraints of at least one of the resources and the at least one offering; and a calculator receiving the characteristics to calculate one or more optimal targets for the organization.

In a second exemplary aspect, the present invention also discloses a method of managing a portfolio of offerings/organizations, including: identifying a business opportunity; evaluating each business opportunity with respect to one or more business objectives; evaluating minimum business requirements for including the business opportunity into a business portfolio; and combining the business opportunity into an optimal portfolio, based upon the evaluating minimum business requirements, wherein the business opportunity comprises one or more of a product, a service offering, a line of business, and an organization.

In a third exemplary aspect, the present invention also discloses a method for determining an optimal revenue target for each offering or organization of a business entity based on business objectives and constraints, including defining one or more of: characteristics of at least one offering of the business entity; characteristics of resources of the business entity; and characteristics of constraints of at least one of the resources and the at least one offering; and calculating, from these characteristics, one or more optimal targets for the business entity.

Thus, the present invention provides a tool and method that can be used by almost any type of organization that can quantify and measure its output to determine optimal targets for each subcomponent of that organization, as well as the overall targets for the organization. Continuing further along these lines, even a government can apply the methods of the invention to an entire industry composed of many organizations, and so on.

The application of this invention (either stand alone, or as a part of a business-intelligence suite) will provide numerous benefits, including better responsiveness and adaptation to market changes, decreased cost of instituting new offerings, increased revenue growth through better alignment with customer needs and market conditions, better planning accuracy and therefore more tuned execution of product/service/organizational delivery.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 shows an exemplary flow diagram 100 of inputs and outputs of a tool 101 embodying the concepts of the present invention, as used for determining targets for revenues to maximize profit for a business;

FIG. 2 shows an exemplary flow diagram 200 of the strategic planning methodology of the present invention as used for determining optimal revenues for different offerings of the organization;

FIG. 3 shows an exemplary flow diagram 300 of the strategic planning methodology of the present invention as used to test new offering proposals and as used for determining optimal portfolios of different offerings of the organization and their optimal revenues;

FIG. 4 demonstrates the sequence 400 used by the exemplary method of the present invention to automatically determine a final optimal determination and a sequence of optimal solutions from the current state to the final optimal determination, is based upon the method of the invention to optimize over a number of sequential cycles of a business;

FIG. 5 shows the sequence 500 in which the exemplary method of the present invention can be used in recursive manner, such that sequentially lower organizational levels in the entity's hierarchy can take the inputs derived by the tool for a higher layer and use these inputs to determine its own targets;

FIG. 6 illustrates an exemplary hardware/information handling system 600 for incorporating the present invention therein; and

FIG. 7 illustrates a signal bearing medium 700 (e.g., storage medium) for storing steps of a program of a method according to the present invention.

### DETAILED DESCRIPTION OF EXEMPLARY EMBODIMENTS OF THE INVENTION

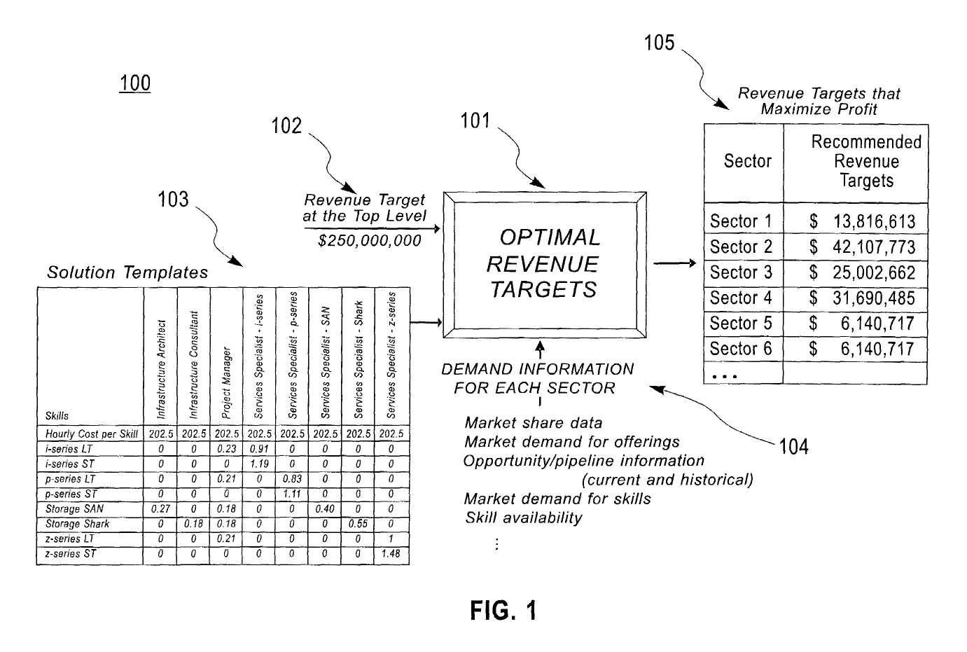

Referring now to the drawings, and more particularly to FIGS. 1-7, an exemplary embodiment showing the method and structures according to the present invention will now be described.

The co-pending application identified above is somewhat related to the present invention in that it also relates to optimizing activities for an organization, including such optimizing such as how many people and skills to provide for a goal and operational activities related to achieving the goals provided as an input such as a target revenue.

In contrast, the present invention addresses the problem of actually determining target goals, such as revenue targets, and thus it will permeate the entire organization's attempts for optimization. Thus, the present invention provides a tool and method so that an organization can determine optimum revenue targets, and all of the subcomponents within the organization will likewise be able to determine its own optimum revenue targets, given an overall target received from a next higher level.

As briefly mentioned previously, the tool and method is also capable of providing a target for the overall organization (e.g., the highest level of the organization) by receiving inputs that describe the environment of the organization, competitor practices, etc., and calculating targets for the overall organization.

Again, it is mentioned, that although revenue targets are the output of the tool and method for purpose of discussing the concepts of the invention, there are other types of targets that the tool and method can calculate, based on the type of organization for which the tool is being used. For example, an organization might be more concerned about target market shares or customer satisfaction. A nonprofit organization might be more concerned about determining optimal targets for benefits provided by that organization.

Moreover, as previously mentioned, even a government can apply the methods of the present invention to an entire industry composed of many organizations or to an entire economy composed of many sectors and parts.

In each instance, the targets determined by the methods of the present invention will be focused on the objectives of the entity, its components, its environment, and the scope of the problem at hand.

FIG. 1 provides a flow diagram 100 that demonstrates how optimal revenue targets are determined by the tool 101 of the present invention. As can be seen from this diagram, a profit optimization problem is used to help determine the “best” revenue targets for each organizational units at different levels of the business entity. This profit optimization problem incorporates revenue projection, cost structure, market potential, various business risks, and so on, as well as the uncertainty associated with each of these factors.

In one exemplary embodiment, the tool 101 performs optimization by converting the inputs 102, 103, 104 into a nonlinear programming problem, by using the methods of the invention to determine an optimal solution of this problem, and by using a commercial or open source package incorporated into the tool to compute the results of this optimal solution.

As used herein, “sector” refers to an area within a unit of a business entity or other organization. The organization could be a business unit, a solution line, a service area, a sector, or any other type of organization, such as a non-profit group or government agency, as long as the organization can quantity its outputs and its resources/constraints. An “offering” is a service or product sold by the company or organization, or possibly something more intangible, such as a brand or other abstraction related to the organization's output.

“Business objectives” can include such quantities as revenues, costs, market share, etc. “Business constraints” can include such quantities a market share, demand, supply, lead times, etc. “Revenue target” is intended in a generic sense as directed to any business metric, regardless of whether it relates to revenues or profits, since some organizations, such as government or non-profit organizations, may be oriented to service or other outputs having at least some metrics other than financial.

Strategic planning on the sector level includes estimating the optimal revenue targets for each sector among existing sectors, given skill availability, solution templates, costs, offering types, market share data, market demand for offerings, etc. All previously mentioned constraints could significantly limit maximum achievable revenue, especially scarce skill availability. Setting revenue targets too high in that case could potentially lead to many lost engagements, which could significantly reduce companies' popularity on the market, and produce many other negative effects.

In the example above, even though solution templates may be the same for each sector, certain parameters, such as skill availability per each sector could be significantly different yielding a specific (sub) optimal split of revenue targets per sector. There could be devised certain myopic rules (regime specific), optimal over long time intervals or in a highly capacitated system, suggesting a desirable revenue target split.

An exemplary risk-based stochastic optimization calculation processing that can be used in tool 101 is illustrated by the following equations, as the tool is used, given revenue demand and supply analysis, for determining optimal revenue targets:

$$max {\sum }_{i = 1}^{E} {λ}_{i} {x}_{i} {rev}_{i} ( 1 - {risk}_{i} ) - {\sum }_{s = 1}^{S} {c}_{s} {C}_{s}$$

$$s . t . {B}_{i} = B \text{(} {η}_{i} ( {x}_{i} ) , {C}_{i )} , i = 1 , … , S \\ 1 - {\prod }_{i = 1}^{S} {( 1 - {B}_{i} )}^{{A}_{ij}} \leq {a}_{j} , j = 1 , … , E$$

$${risk}_{j} = {\prod }_{i = 1}^{S} {( 1 - {B}_{i} )}^{{A}_{ij}} , j = 1 , … , E$$

$$0 \leq {x}_{i} \leq 1$$

where λᵢ represent arrival rates of specific offering types, xᵢ s represent the proportion of selected (accepted) offerings for each type, revᵢ is a revenue rate per each offering of type i, riskᵢ represents the probability of losing a selected offering of type i due to insufficient staffing. Furthermore, cₛ is a cost rate per unit of a particular resource type s and Cₛ is the amount of available resources of type s.

The above analytic approach includes a combination of advanced probabilistic methods and advanced nonlinear (but including linear as a special case) optimization methods. An objective is to find offering selection policies that will maximize expected profit rate. Constraints contain mutual relationships between system parameters, such as offering arrival rates, capacities of available resources and induced risks of losing specific offerings. Risks are subject to given tolerances.

Possible alternatives to the nonlinear (with linear being a special case) approach include stochastic loss networks, stochastic queuing networks, stochastic programming models, stochastic dynamic programming models, deterministic dynamic programming models, stochastic optimal control models, deterministic optimal control models and stochastic programming. However, the present invention is not limited to these alternatives and can incorporate any probabilistic and optimization models relevant to optimal assignment.

The calculations of specific results of an optimal solution obtained from the methods of the present invention can be done by using solvers called from C/C++ programs. Details of the result calculations itself is not considered particularly important to the present invention, since such result calculation is well known in the art. In an exemplary embodiment, the IPOPT solver, which is an open source software, very convenient, and fast in search for results in an optimal solution of large scale problems, is specifically used. Specialized and proprietary solvers can also provide such results for large scale problems.

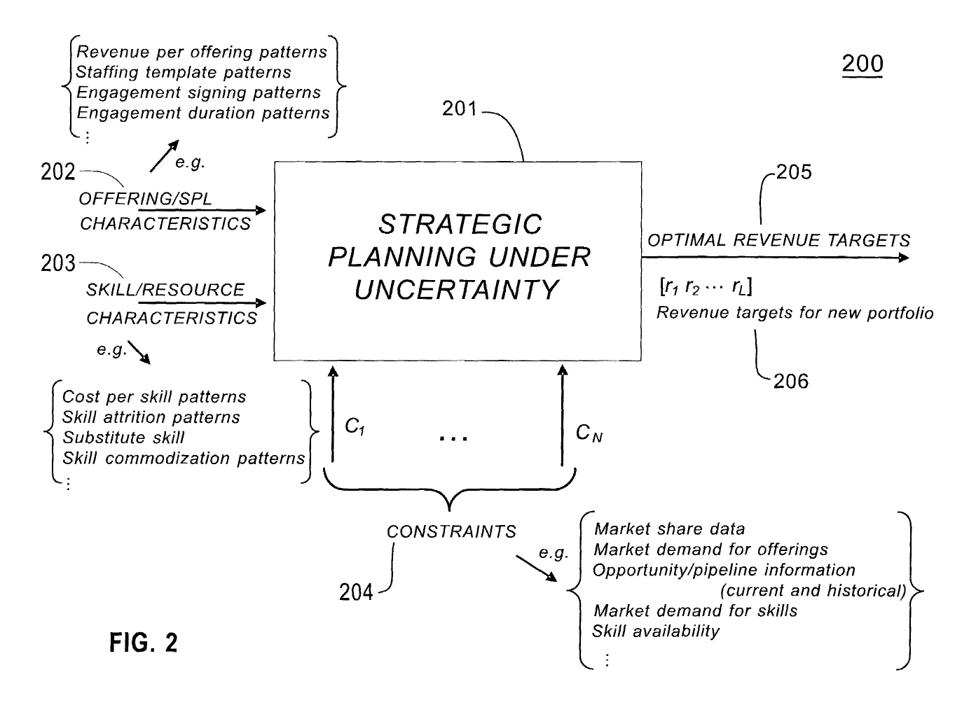

FIG. 2 shows how the method 200 of the present invention can be used for strategic planning of determining optimal targets as based on the organization's different offerings. In this usage, the optimization tool 201 will receive as inputs characteristics of an offering 202, characteristics of skills/resources 203, and constraints 204, to provide optimal revenue targets 205, including perhaps optimal targets in a vector format 206 for more than one offering.

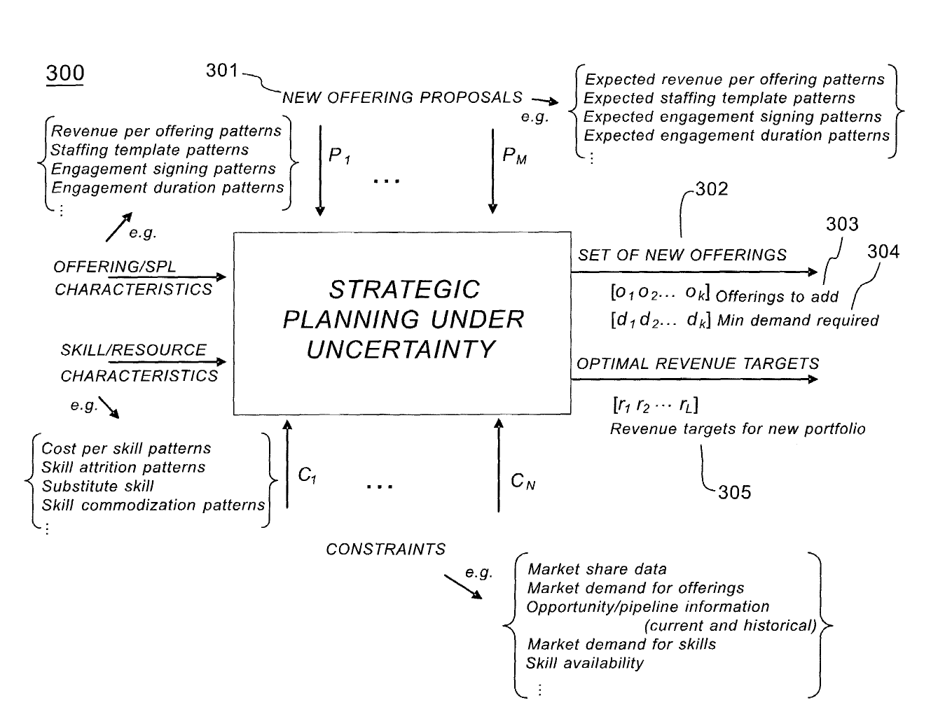

FIG. 3 shows yet another exemplary embodiment of the method of the present invention. In this third embodiment, the tool 201 additionally receives characteristics of potential new offerings 301 and can provide additionally a set of new offerings 302, as well as the optimal revenue targets 205, which includes an optimal portfolio of offerings and the corresponding optimal revenue targets. The new offering set 302 can include a listing of these new offerings 303 that can be added and a listing of minimum demands 304 required by the organization for each of these new offerings.

This application of the tool shown in FIG. 3 can be considered as a method for an organization to evaluate business opportunities as a strategy to optimally manage its portfolio of “offerings/organizations.” It is noted that the term “organization” includes the re-organization of the organization to better utilize the mix of resources and constraints.

In this strategy, a business entity would identify a potential business opportunity, where a business opportunity could be a product, service offering, line of business, organization, etc. Each business opportunity is evaluated with respect to the entity's business objectives. By sorting through the minimum demand requirements 304, and combining as appropriate, an optimal offering/organization portfolio can be developed.

In the non-limiting three exemplary embodiments shown in FIGS. 1-3, assuming that the organization is a business entity interested in optimal revenues or profits, the present invention should also be recognized as a methodology for determining optimal revenue targets (or other type of organizational targets) for each “offering/organization” of a business entity, based on business objectives and constraints (hierarchy).

“Revenue target” is only one example of a business metric that might be optimized, since the method of the present invention applies equally to any generic business metric or combination of metrics. An “offering” can be any of a product, service, brand, etc. An organization can be any of a business unit, a solution line, a service area, a sector, etc. A business objective can include any of revenue, cost, market share, etc. Business constraints can include market share, demand, supply, lead times, etc.

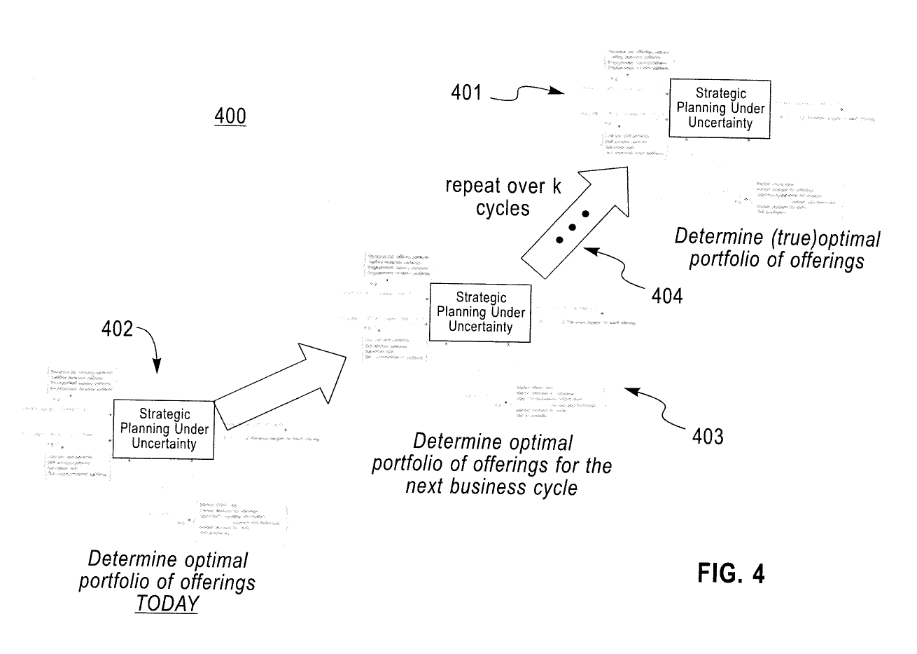

FIG. 4 shows another exemplary embodiment 400 of the present invention as used to longer term planning 401 of an optimal sequence of portfolios over any time horizon of interest. In one variation of this exemplary embodiment, the tool and method is used to determine a first optimal portfolio 402 and outputs of the tool for this first business cycle become inputs for exercising the tool for a second cycle 403. This sequence is repeated for k cycles until the desired number of business cycles 401 is reached. In another variation of this exemplary embodiment, the tool and method is used to determine an optimal sequence of optimal portfolios 402, 403, 404, 401 over the entire horizon of business cycles as a single business cycle. The present invention supports both variations, where the first variation is a special (less general) case of the second variation, as well as any combination of these and related variations.

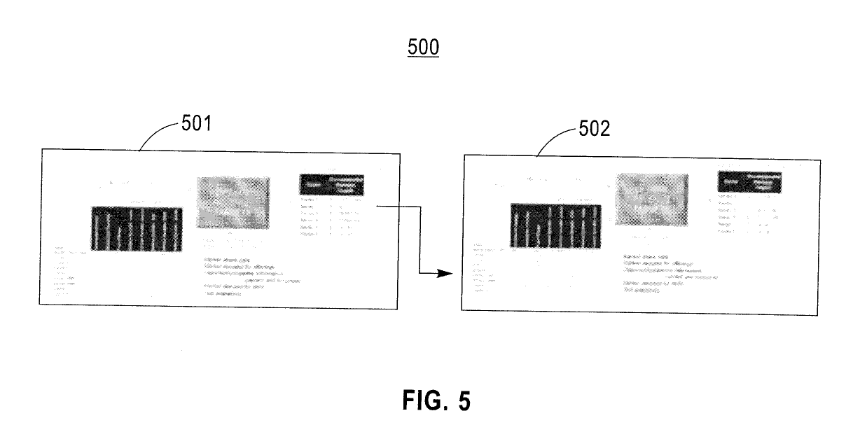

FIG. 5 demonstrates another aspect of the present invention, the feature of recursiveness. In the sequence 500 shown in FIG. 5, the tool 101 such as shown in FIG. 1, is first used to provide optimal targets at one level of the organization, such as the overall organization. In a next use of the tool is then used by a sector, division, subcomponent, or other level of the organization to take the optimal targets provided from a higher level and then apply the method of the present invention to that lower level. Depending upon the structure of the organization, this recursive application could be done any number of times, each time taking results from a higher level and exercising the method at a lower level, in view of the resources and constraints of that lower level.

Thus, from the discussion above, it can be seen that the present invention is able to provide targets for an organization such that the overall objectives and targets of the organization permeate the targets of all levels within the organization.

Moreover, from the above four exemplary embodiments and the recursive feature described in FIG. 5, the present invention should also be recognized as a methodology for determining a set of actions, policies, portfolios, and/or revenue targets (or other types of organizational targets) to move from the current state of the business entity to a truly optimal state, further determining optimal states along the way.

In addition to the aspects of the tool used to perform the risk-based optimization calculations described above, the present invention includes the aspect of optimal strategic planning for an organization, by taking into account an overall objective perspective of the organization's mix of available skills/resources to determine an optimal mix of revenue targets today, as well as assist in determining the actions/policies/portfolios that should be taken to move the organization to a truly optimal mix.

As new “offerings” or “organizations” are presented for evaluation, the present invention includes the determination of the minimum demand that would justify including the new offering/organization into the current portfolio, as well as evaluation of a set of new offering proposals, which would drive the most revenue/profit and to what extent they should be pursued.

### Exemplary Hardware Implementation

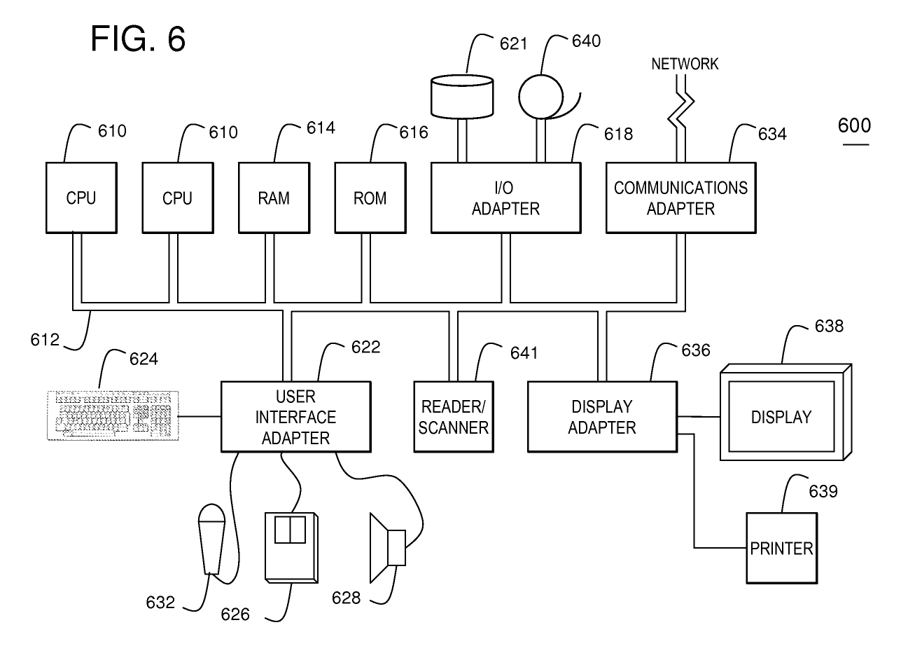

FIG. 6 illustrates a typical hardware configuration of an information handling/computer system in accordance with the invention and which preferably has at least one processor or central processing unit (CPU) 611.

The CPUs 611 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communication adapter 634 for connecting an information handling system to a data processing network, the Internet, an Intranet, a personal area network (PAN), etc., and a display adapter 636 for connecting the bus 612 to a display device 638 and/or printer 639 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 611 and hardware above, to perform the method of the invention.

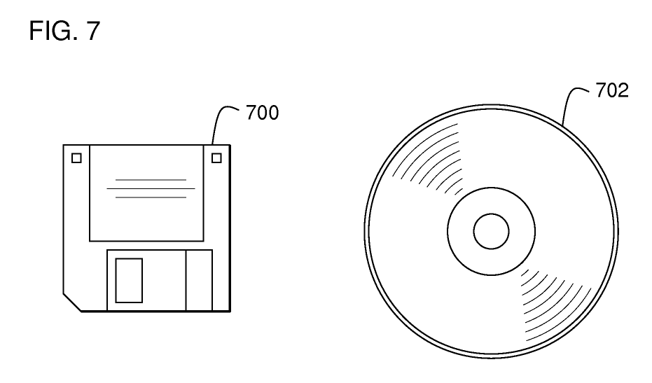

This signal-bearing media may include, for example, a RAM contained within the CPU 611, as represented by the fast-access storage for example. Alternatively, the instructions may be contained in another signal-bearing media, such as a magnetic data storage diskette 700 (FIG. 7), directly or indirectly accessible by the CPU 611.

Whether contained in the diskette 700, the computer/CPU 611, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code. The present invention can be used either stand alone, or as a part of a business-intelligence suite. It can provide numerous benefits, including better responsiveness and adaptation to market changes, decreased cost of instituting new offerings, increased revenue growth through better alignment with customer needs and market conditions, better planning accuracy and therefore more tuned execution of product/service/organizational delivery.

While the invention has been described in terms of a single exemplary embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A computerized organization optimization tool, comprising:
an input port to receive one or more of:
characteristics of at least one offering of said organization;
characteristics of resources of said organization; and
characteristics of constraints of at least one of said resources and said at least one offering; and
a calculator receiving said characteristics to calculate one or more optimal targets for said organization.

2. The tool of claim 1, wherein at least one of said characteristics is expressed in terms of an uncertainty.

3. The tool of claim 2, wherein said calculator calculates a risk-based stochastic optimization.

4. The tool of claim 1, wherein said calculator converts said characteristics into an optimization problem, solves said optimization problem to determine an optimal solution of said one or more optimal targets, and invokes a solver to compute values of said one or more optimal targets from said optimal solution.

5. The tool of claim 1, wherein said calculator calculates said one or more optimal targets relative to a specific time increment that is selectable by a user.

6. The tool of claim 5, wherein said calculator selectively uses one or more results calculated for said specific time increment as inputs to solve said one or more optimal targets for a succeeding time increment.

7. The tool of claim 1, wherein:
said organization comprises a plurality of sectors; and
said calculator calculates said one or more optimal targets as identified to be relative to said sectors.

8. The tool of claim 1, further including means for selectively having a recursive capability such that one or more results of said calculator is usable as inputs for calculating one or more optimal targets for any of a different level, component, or sub-component of said organization.

9. The tool of claim 1, wherein said optimal targets comprise a determination of an optimal mix of offerings for said organization.

10. The tool of claim 9, further including means for selectively receiving characteristics of one or more potential offerings for said organization, and said optimal mix of offerings includes an evaluation of said one or more potential offerings.

11. The tool of claim 1, wherein said organization comprises a business entity and said one or more optimal targets comprise revenue targets for at least one of one or more offerings of said business entity and one or more organizations of said business entity.

12. The tool of claim 3, wherein said risk-based stochastic optimization comprises an optimization of:
$$max {\sum }_{i = 1}^{E} {λ}_{i} {x}_{i} {rev}_{i} ( 1 - {risk}_{i} ) - {\sum }_{s = 1}^{S} {c}_{s} {C}_{s}$$
$$s . t . {B}_{i} = B \text{(} {η}_{i} ( {x}_{i} ) , {C}_{i )} , i = 1 , … , S \\ 1 - {\prod }_{i = 1}^{S} {( 1 - {B}_{i} )}^{{A}_{ij}} \leq {a}_{j} , j = 1 , … , E$$
$${risk}_{j} = {\prod }_{i = 1}^{S} {( 1 - {B}_{i} )}^{{A}_{ij}} , j = 1 , … , E$$
$$0 \leq {x}_{i} \leq 1$$
where λᵢ represents arrival rates of specific offering types, xᵢ represents a proportion of selected (accepted) offerings for each type, revᵢ comprises a revenue rate per each offering of type i, riskᵢ represents a probability of losing a selected offering of type i due to insufficient staffing, cₛ comprises a cost rate per unit of a particular resource type s, and Cₛ comprises an amount of available resources of type s.

13. A signal-bearing medium tangibly embodying a program of machine-readable instructions executable by a digital processing apparatus to function as said computerized organization optimization tool of claim 1.

14. A method of providing a service to an organization, said method comprising:
providing said organization with an output of said computerized organization optimization tool of claim 1.

15. A method of managing a portfolio of offerings/organizations, said method comprising:
evaluating a business opportunity with respect to one or more business objectives;
evaluating a minimum business requirement for including said business opportunity into a business portfolio; and
combining said business opportunity into an optimal portfolio, based upon said evaluating said minimum business requirement,
wherein said business opportunity comprises one or more of a product, a service offering, a line of business, and an organization.

16. The method of claim 15, wherein said evaluating each said business opportunity with respect to one or more business objectives comprises:
using a computerized organization optimization tool, said tool comprising:
an input port to receive one or more of:
characteristics of at least one offering of said organization;
characteristics of resources of said organization; and
characteristics of constraints of at least one of said resources and said at least one offering; and
a calculator receiving said characteristics to calculate one or more optimal targets for said organization.

17. The method of claim 16, wherein a new business opportunity is evaluated by calculating a minimum demand that would justify adding a new offering to a current portfolio of offerings.

18. The method of claim 16, wherein said computerized organization optimization tool converts said characteristics into an optimization problem, solves said optimization problem to determine an optimal solution of said one or more optimal targets, and invokes a solver to compute values of said one or more optimal targets from said optimal solution.

19. A method of determining an optimal revenue target for each offering or organization of a business entity based on business objectives and constraints, said method comprising:
defining one or more of:
characteristics of at least one offering of said business entity;
characteristics of resources of said business entity; and
characteristics of constraints of at least one of said resources and said at least one offering; and
calculating, from said characteristics, one or more optimal targets for said business entity.

20. The method of claim 19, wherein said calculating one or more optimal targets comprises:
converting said characteristics into an optimization problem;
solving said optimization problem to determine an optimal solution of said one or more optimal targets; and
invoking a solver to compute values of said one or more optimal targets from said optimal solution.
